(19) United States
(12) Patent Application Publication
(10) Pub. No.: US 2002/0183100 A1
(43) Pub. Date: Dec. 5, 2002

(54) Character selection method and character selection apparatus

(76) Inventor: John Parker, Berkshire (GB)

Correspondence Address: WHITHAM, CURTIS & CHRISTOFFERSON, P.C., SUITE 340, 11491 SUNSET HILLS ROAD, P.O. BOX 9204, RESTON, VA, 20190, US

(21) Appl. No.: 10/106,034

(22) Filed: Mar. 27, 2002

(30) Foreign Application Priority Data
Mar. 29, 2001 (GB) 0107931.8

(51) Int. Cl. H04B 1/38

(52) U.S. Cl. 455/566; 455/90

(57) ABSTRACT

A character selection method and a character selecting apparatus for use in electronic devices from a reduced keypad in which each key has a plurality of characters assigned to it, and the method comprise the steps of; detecting a key press; selecting one of the characters assigned to the key for display in dependence on the probability of that character appearing at that location in a character string; repeatedly selecting a further character assigned to the key for display if the first displayed character is not a desired character for that location, until the desired character is displayed; and, assigning the selected character to that location.

### BACKGROUND OF THE INVENTION

1. Field of the Invention

Present invention relates to a method and apparatus for character selection during string construction such as may be used in reduced keypad applications e.g. mobile phones.

2. Description of the related art

Text messaging (E-mail) on telecommunications devices is now widely available and phone operators have experienced a huge increase in the use of text messaging over recent years. Users require an easy to use service for text messaging that they can operate quickly and conveniently. In most systems for text messaging, each key of the phone unit is assigned more than one character. Traditionally there has been no predictive text feature and selection of the desired character is achieved by pressing a key more than once while the characters assigned to that key cycle through a predefined order while displayed on the display unit. This method necessitates a significant increase in the number of key presses required to enter a desired string and is time consuming to the user.

An algorithm has been proposed in EP-A-0842463 which enables the user to construct a string without the inconvenience of pressing a key more than once. When the user requires a character he presses the key associated with that character only once. At this point the user has not defined which character is assigned to that position in the string, only that one of the characters associated with the key is assigned to that position. For any number of characters entered in a string the algorithm searches its database for possible words which are constructed from the key order entered by the user. For example, characters A,B and C are assigned to a key for number 2. And characters G,H and I are assigned to a key for number 4. Under this condition, if the user presses the key for number 2 first, and the key for number 4 second, then the key for number 4 third in order to construct a string “BIG”. It is possible to construct 27 combination from AGG, AGH, AGI . . . through CII. Then the most likely word is presented to the user on the display unit based on statistical probability by the algorithm. As more characters are added to the word the probability of the user requiring a particular word may change and therefore the word may change between characters associated with the keys. That is, Having pressed the keys required to complete the word the algorithm will recommend the most probable word based on statistics but will also offer alternative words from its database that are constructed from the same sequence of key presses.

Problems associated with this algorithm include the large size of the dictionary database required to contain words of all lengths. The change in the sequence of characters in the word as more characters are added can be confusing to the user. Also, text messaging is usually an informal means of communication with users often using slang expressions or words not appearing in the dictionary. If the user is attempting to type a word which is not recognized by the database of the algorithm, that word may not be offered to the user on completion of the key presses thus causing confusion and further wasting time. Since text messaging is also generally a rushed exercise spelling mistakes are frequent but this is not so important. Because it is possible to understand the meaning of message even if the spelling mistake is included in the massage. However, it is a problem when using the algorithm due to the reasons mentioned above. That is, since the algorithm searches the database according to the string including spelling mistake, the algorithm could not find desired word.

### SUMMARY OF THE INVENTION

A preferred embodiment of the present invention provides a character selection method and character selection apparatus. The assigning of characters to a particular key remains unchanged. However, the order in which a character is presented to the user is dependent upon the preceding characters in the string. The most likely character is presented first on the display unit 20 as calculated from the statistical database. The statistical database is generated by considering the probability of a pattern of characters occurring from the beginning of a word. A further press of the key will present the second most likely character and so on.

A further preferred embodiment contains two databases; a first database is accessed to assess the likelihood of the user requiring a character associated with a given key for any of, e.g. the first three, letters of a word (as in the first preferred embodiment). That is, the first database includes not only word constituted within three characters but also first three character of words constituted by characters not less than four. On the other hand, the second database is accessed to predict the likelihood of the user requiring a character associated with a given key when the word exceeds a defined number of characters (e.g. 3), the statistical probability for successive characters (e.g. 4 and above) is calculated by looking at the stem of the word and calculating which letter is the most probable of those assigned to the pressed key by using a dictionary.

When input a following character, on pressing a key the order that the associated letters are offered to the user is determined by the likelihood of each associated letter appearing considering the previous letters in the word which are now fixed in position and displayed to the user. If the first character offered is not accepted a further press of the key will offer the second most likely character, this process continues until all possible characters have been offered to the user at which point the process begins again with the most likely character. Since the first statistical database is generated only from the patterns of characters from the start of the string, the statistics will not be affected by patterns of characters that frequently appear in other regions of the string, e.g. “ing” which frequently appears at the end. For this reason, a capacity of the database is smaller than a database including all length word. Therefore, the accuracy of character selection at the start of the word will increase. The second statistical database only includes words containing more than a defined number of characters e.g. 4 and therefore requires less memory than the corresponding database from EP-A-0842463 which contains words of all lengths.

Since the statistically more likely letters are offered in preference to the less likely letters for a given key, in general, fewer key presses will be required by the user to type a chosen word. All characters are offered to the user in turn even if the probability of a particular character order is extremely low. Having selected a character in a particular position in the string, that character is then fixed in its position and will not change regardless of successive characters added to the string. The algorithm is also adaptable and the statistical probability of the user using certain words will be updated taking into account words frequently used by the user. Words and character patterns will also be added to the databases in the same way. Therefore, it is easy to input the string even if it is not frequently used word (e.g. slung) in second time.

### BRIEF DESCRIPTION OF THE DRAWING

FIG. 1 is a typical mobile phone in which several characters are associated with each key and the selected characters are displayed on the display unit;

FIG. 2 is block diagram showing the character selection apparatus according to the present invention; and

FIG. 3 is a flow chart showing the character selection method according to the present invention.

### DESCRIPTION OF THE PREFFERED EMBODIMENT

An embodiment of the invention will now be described in detail by way of example with reference to the accompanying drawings.

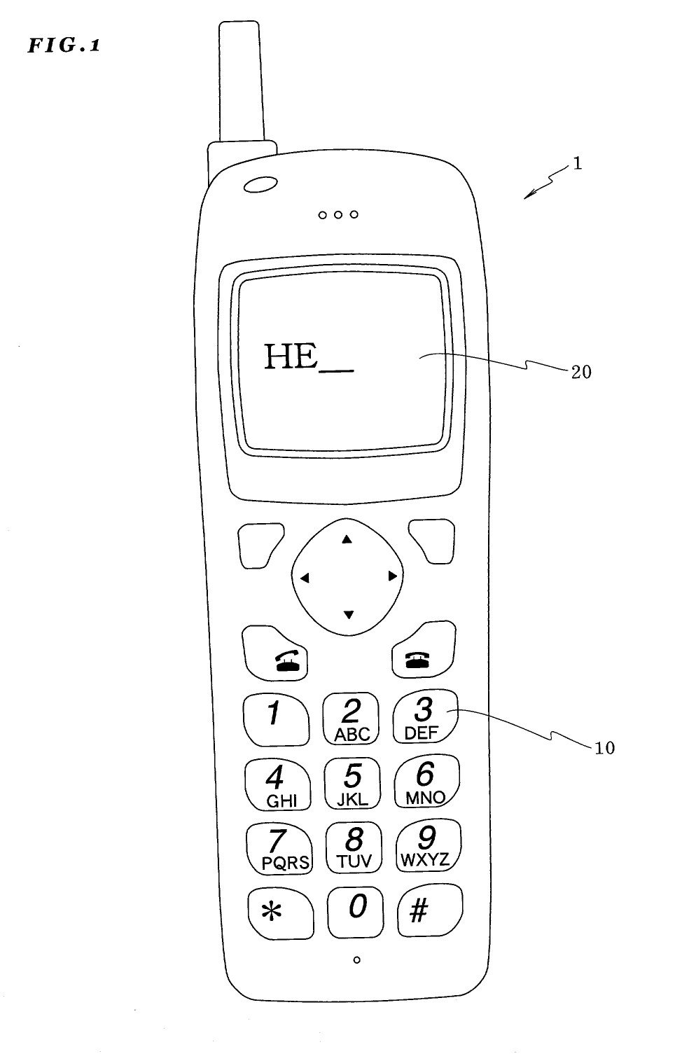

In FIG. 1, characters are shown to be associated with the keys 10 of the phone 1, e.g. The letter J can be presented on the display unit 20 through pressing key for number 5.

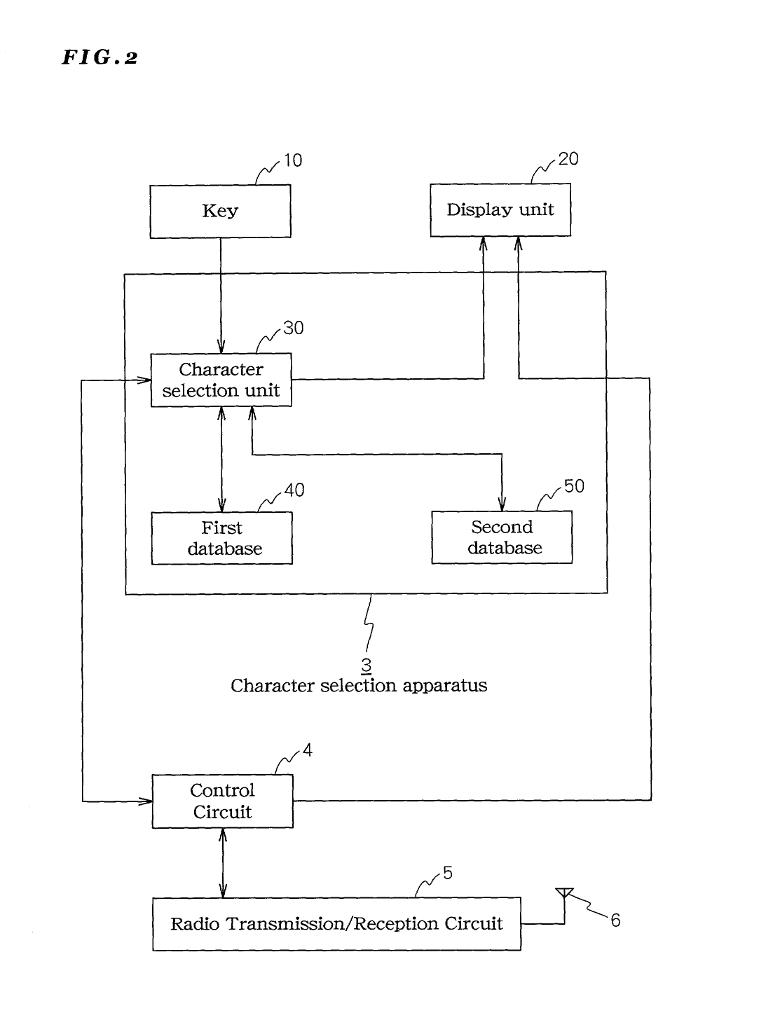

Next, it is explained about character selection apparatus 3 and other peripheral devices according to present embodiment. FIG. 2 is a block diagram showing character selection apparatus 3 other peripheral devices. As showing in the FIG. 2, the character selection apparatus 3 comprises, a character selection unit 30, first database 40, second database 50. The character selection unit 30 receives an information from the key 10, and accesses to the first or second database, then displays the selected character on the display unit 20. Further, a control circuit 4 and a radio transmission/reception circuit 5 are connected to the character selection apparatus 3.

The radio transmission/reception circuit 5 is same to conventional circuit. The radio transmission/reception circuit 5 receives a radio signal from antenna 6 and processes the radio signal, then sent to the control circuit 4. Moreover, the radio transmission/reception circuit 5 receives a signal generated in the mobile phone 1 and send the signal to the antenna 6 as radio signal. Here, the signal is voice signal, character, massage or image data, etc. The control circuit 4 has a function for controlling operations of the character selection unit 30, display unit 20 and the radio transmission/reception circuit 5.

Next, it is explained about the first database and the second database. A plurality of words and head portion of words constituted with predetermined number of characters are stored in the first database. For example, if the predetermined number is three, words and head portion of words constituted with three characters or less. That is, since “on” or “and” is constituted with two or three characters, these words are stored as it is. On the other hand, since “hello” is constituted with five character, this word is not store as it is. Only head portion “hel” is stored.

With respect to the second database, a plurality of words having over four characters are stored. For example, if the predetermined number is three, only words having over four characters are stored in the second database. Thus, as described below, the access for the databases from the character selection unit 3 is switched according to a location in a string.

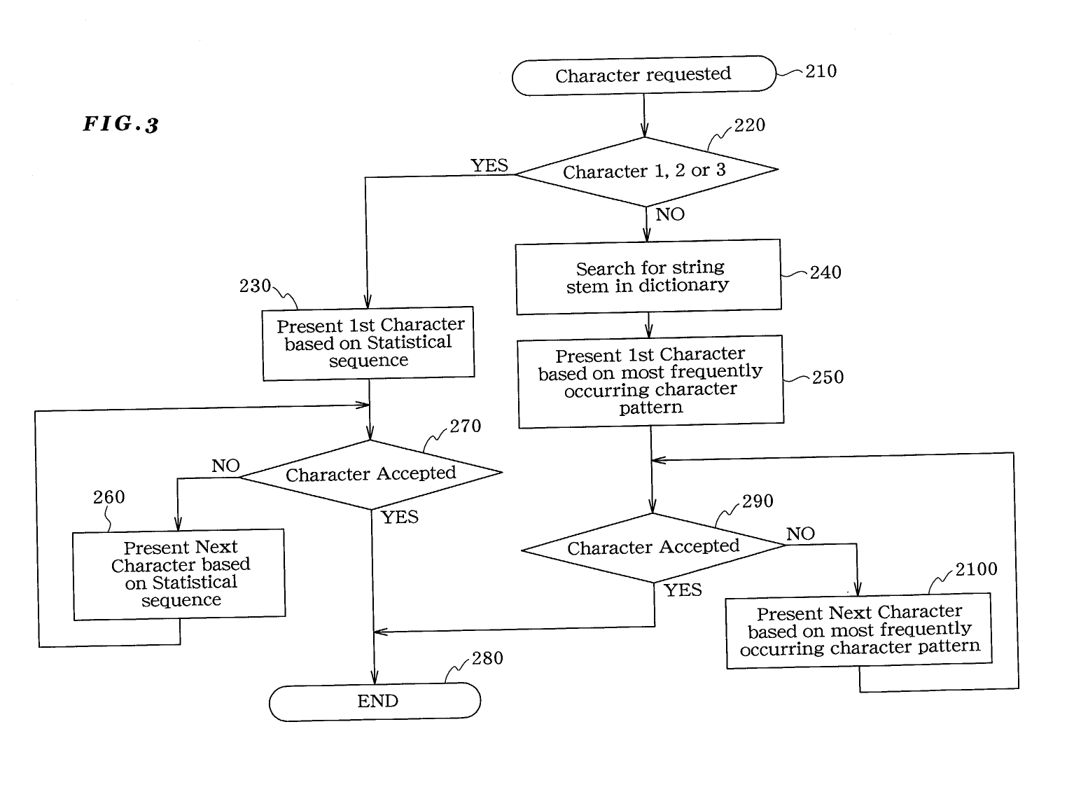

Next, a character selection method according to present embodiment is described referencing FIG. 3. At 210 in FIG. 3, a particular key is selected by the user. The system determines whether the character is to be positioned within the first 3 characters of the string at 220. This will be the case for the first three characters selected. If the letter is positioned within the first 3 letter of the word the first algorithm is accessed and the most likely letter associated with the key is presented based on the pattern of letters in the string at 230. At 270 the user determines whether the offered letter is required. If the letter is required the user may proceed and fix the chosen letter to its position within the string at 280. If the presented letter is not required then the user may press the key again and the database will offer the second most likely letter at 260. Once again the user may accept the letter at 270. If the character is still not required then further presses of the key will continue to offer all letters associated with the key.

If the character is not positioned within the first 3 characters of a string at 220 then the second database is accessed at 240. The database searches for the stem of the word in its dictionary. The probability of each letter associated with the key being required is assessed from the word stem and at 250 the most likely character is presented. If the user wishes to accept this character at 290 then he may proceed at 280. If the offered character is not correct then a further press of the same key at 2100 will present the second most likely letter based on statistics. Once again, further presses of the key will bring up successive letters associated with that key until the required letter is presented.

As an example consider a user typing the word “HELLO”. ON an existing mobile phone without predictive text entry, the sequence of key presses is as follows:

| | | | | | | | |
|---|---|---|---|---|---|---|---|
| 4(GHI) | 4(GHI) | 3(DEF) | 3(DEF) | 5(JKL) | 5(JKL) | 5(JKL) | 5 |
| | | | | | | | (JKL) |
| | H | | E | | | L | |
| 5(JKL) | 5(JKL) | 6 | 6 | 6 | | | |
| | | (MNO) | (MNO) | (MNO) | | | |
| | L | | | O | | | |

With predictive character selection embodying the present invention it is most likely that the word HELLO can be entered as follows:

| | | | | | |
|---|---|---|---|---|---|
| 4(GHI) | 4(GHI) | 3(DEF) | 5(JKL) | 5(JKL) | 6(MNO) |
| | H | E | L | L | O |

In this example the number of key presses has been reduced from 13 to 6 and the algorithm can be described as follows:

The user wishes to commence the word with the letter H. On depressing the key associated with the letter H, key for number 4, the database calculates which of the associated letters is most likely to be required to start a word. The letter G has the highest probability and so is initially offered to the user. Since the letter G is not required, a second depression of the key offers the second highest probability letter, the letter H. Since H is required the user may progress to the next letter. The user now wishes to enter the character E and presses the key for number 3 (DEF) Under the rules of character selection with no predefined sequence two presses of the key would be required to select the letter E. However the database considers the probability of each of the letters associated with the key following the letter H as the second letter in the string. The letter with the highest probability is E and so is offered first to the user. The third letter is obtained in a similar way following the string HE at the start of a word.

On selecting a fourth character the dictionary database is accessed. In this case the database looks at the stem of the word, HEL, and calculates the probability of the next letter being a J, K or L based on the number of words in the dictionary that begin, HELJ, HELK and HELL. Since the most probable is HELL, L is offered as the fourth letter.

Similarly the database presents the fifth letter with reference to the stem HELL.

In a second example the forth letter of the word BENEFIT may be selected. The character sequence BEN has already been entered. On depressing the key for number 3 (DEF), the word may take one of 3 possibilities; BEND, BENE or BENF. If the dictionary contains 5 words beginning with BEND, 4 words beginning with BENE and 0 words beginning with BENF, the character D will be offered first, followed by E and finally F.

In a simplified embodiment, only the first algorithm based on statistical probability need be used. However, the database increases significantly in size to accommodate words longer than 4 characters and therefore the second embodiment described above is preferred.

What is claimed is:

1. A method for character selection for use in electronic devices from a reduced keypad in which each key has a plurality of characters assigned to it comprising the steps of;
detecting a key press
selecting one of the characters assigned to the key for display in dependence on the probability of that character appearing at that location in a character string;
selecting a further character assigned to the key for display TO if the first displayed character is not a desired character for that location;
repeating previous step until the desired character is displayed; and
assigning the selected character to that location.

2. A method for character selection according to claim 1, wherein if the character is the first character of the string the probability of the character being the desired character for that location is determined from a database containing the number of recognized strings beginning with that character.

3. A method for character selection according to claim 1, wherein if the character is positioned within a predefined number of characters from the start of the string the probability of that character being the desired character for that location is determined from a database containing the statistical probability of that character following the previous characters in the string.

4. A method for character selection according to claim 1, wherein if the character is positioned after a predefined number of characters from the start of the string, the probability of that character being the desired character for that location is determined from a dictionary database.

5. A method for character selection according to claim 2, wherein said databases are adaptive.

6. A method for character selection according to claim 1, wherein upon pressing a key the order with which the characters associated with the key are displayed to the user is dependent on the probability of the characters being the desired character for that location in the string as determined by said databases.

7. An apparatus for character selection for use in electronic devices from a reduced keypad in which each key has a plurality of characters assigned to it, wherein the apparatus including a character selection unit, predetermined databases accessed by the character selection unit, and the character selection unit having functions of;
detecting a key press
selecting one of the characters assigned to the key for display in dependence on the probability of that character appearing at that location in a character string based on the databases;
repeatedly selecting a further character assigned to the key for display if the first displayed character is not a desired character for that location until the desired character is displayed; and
assigning the selected character to that location.

8. An apparatus for character selection according to claim 7 wherein if the character is the first character of the string the probability of the character being the desired character for that location is determined from a database containing the number of recognized strings beginning with that character.

9. An apparatus for character selection according to claim 7 wherein if the character is positioned within a predefined number of characters from the start of the string the probability of that character being the desired character for that location is determined from a database containing the statistical probability of that character following the previous characters in the string.

10. An apparatus for character selection according to claim 7, wherein if the character is positioned after a predefined number of characters from the start of the string, the probability of that character being the desired character for that location is determined from a dictionary database.

11. An apparatus for character selection according to claim 8, wherein said databases are adaptive.

12. An apparatus for character selection according to claim 7, wherein, upon pressing a key the order with which the characters associated with the key are displayed to the user is dependent on the probability of the characters being the desired character for that location in the string as determined by said databases.
